(19) United States
(12) Patent Application Publication
(10) Pub. No.: US 2020/0321025 A1
(43) Pub. Date: Oct. 8, 2020

(54) MAGNETIC RECORDING MEDIUM, LAMINATE, AND FLEXIBLE DEVICE

(71) Applicant: SONY CORPORATION, Tokyo (JP)

(72) Inventors: Eiji NAKASHIO, Miyagi (JP); Yuta AKIMOTO, Miyagi (JP); Tomoe SATO, Miyagi (JP); Yoichi KANEMAKI, Miyagi (JP); Nobuyuki SASAKI, Miyagi (JP); Masaru TERAKAWA, Miyagi (JP); Kazuya HASHIMOTO, Miyagi (JP); Katsunori MAESHIMA, Miyagi (JP); Minoru YAMAGA, Miyagi (JP); Hikaru TERUI, Miyagi (JP); Hiroyuki KOBAYASHI, Tochigi (JP)

(73) Assignee: Sony Corporation, Tokyo (JP)

(21) Appl. No.: 16/099,298

(22) PCT Filed: May 11, 2017
(86) PCT No.: PCT/JP2017/017885

§ 371 Date: Nov. 6, 2018

(30) Foreign Application Priority Data
May 11, 2016 (JP) 2016-095333

(51) Int. Cl. G11B 5/706; B32B 7/022

(52) U.S. Cl. CPC G11B 5/70605; B32B 7/022

(57) ABSTRACT

A magnetic recording medium includes an elongated substrate, and a reinforcing layer and a carbon thin film disposed on one surface of the substrate.

### TECHNICAL FIELD

The present technology relates to a magnetic recording medium, a laminate, and a flexible device. Specifically, the present technology relates to a magnetic recording medium including a reinforcing layer, a laminate, and a flexible device.

### BACKGROUND ART

In recent years, the amount of information has explosively increased due to spread of the Internet and big data analysis. It is desired to further increase the capacity of a recording medium for backing up and archiving such information as data. Among various storage systems, merits of a magnetic tape are being recognized once again recently as a low bit cost and green storage. Concerning an increase in density of the magnetic tape, the world record of 148 gigabits per square inch has been established recently, and the increase in density shows no sign of stopping.

In a magnetic tape housed in a cartridge in a state of being wound around a reel, a system such as a linear recording type linear-tape-open (LTO) for performing record and reproduction in a longitudinal direction of the tape using a fixed head in which a large number of magnetoresistive heads is disposed for high capacity has been put into practical use. In order to further increase the capacity, development of a magnetic powder of a coating type magnetic recording layer and development of a recording layer such as a sputtered magnetic layer are actively performed. This makes it possible to narrow a recording bit length and to improve a longitudinal recording density (generally linear recording density) of a tape.

Meanwhile, the magnetic tape uses a flexible film-shaped substrate, and therefore has a very wide recording track width as compared with a magnetic disk. Concerning the increase in density of the magnetic tape, if the track density in a tape width direction can be improved together with development of the above recording layer, the recording density is dramatically improved. In this case, a linear recording density does not change. Therefore, for example, reduction in an output due to a slight spacing between a magnetic recording layer and a head is suppressed. It is considered that development of technology for increasing the track density has a large advantage in development of a tape drive.

When a track density in a tape width direction is increased in a current magnetic tape, the size of the tape itself is changed due to fluctuation in a width direction during traveling of the tape and an environmental factor such as temperature or humidity. As a result, so-called off-track occurs, for example, the track is not present at a track position that should be originally read by a magnetic head, or a shifted track position is read. As the thickness of the tape decreases for higher density, a change in a tape width due to a tension factor further increases. Therefore, an influence of off-track may become significant, and tape traveling performance may become unstable.

Meanwhile, there has been proposed technology of reinforcing a substrate by disposing a reinforcing layer containing a metal, an alloy, or an oxide thereof on one surface or both surfaces of the substrate (for example, see Patent Documents 1 to 6).

### CITATION LIST

### Patent Document

### Patent Document 1: Japanese Patent Application Laid-Open No. 61-13433

### Patent Document 2: Japanese Patent Application Laid-Open No. 11-339250

### Patent Document 3: Japanese Patent Application Laid-Open No. 2000-11364

### Patent Document 4: Japanese Patent Application Laid-Open No. 2002-304720

### Patent Document 5: Japanese Patent Application Laid-Open No. 2002-304721

### Patent Document 6: Japanese Patent Application Laid-Open No. 2003-132525

### SUMMARY OF THE INVENTION

### Problems to be Solved by the Invention

However, if a reinforcing layer is disposed on a substrate, so-called cupping in which the shape of a tape curves in a width direction increases. As a result, a spacing is generated between a magnetic head for writing and reading and a magnetic tape, and recording and reproducing characteristics are deteriorated. Therefore, a magnetic tape having excellent dimensional stability and capable of suppressing cupping is desired.

Furthermore, as well as the magnetic tape, a flexible device or the like having excellent dimensional stability and capable of suppressing curvature is desired.

Therefore, a first object of the present technology is to provide a magnetic recording medium having excellent dimensional stability and capable of suppressing cupping.

Furthermore, a second object of the present technology is to provide a laminate having excellent dimensional stability and capable of suppressing curvature, and a flexible device.

### Solutions to Problems

In order to solve the above problems, a first technique is a magnetic recording medium including an elongated substrate, and a reinforcing layer and a cupping suppressing layer disposed on one surface of the substrate.

A second technique is a magnetic recording medium including an elongated substrate, and a reinforcing layer and a carbon thin film disposed on one surface of the substrate.

A third technique is a laminate including a substrate, and a reinforcing layer and a cupping suppressing layer disposed on one surface of the substrate.

A fourth technique is a laminate including a substrate, and a reinforcing layer and a carbon thin film disposed on one surface of the substrate.

A fifth technique is a flexible device including the laminate according to the third or fourth technique.

### Effects of the Invention

As described above, according to present technology, it is possible to realize a magnetic recording medium having excellent dimensional stability and capable of suppressing cupping. Furthermore, it is possible to realize a laminate having excellent dimensional stability and capable of suppressing curvature.

### BRIEF DESCRIPTION OF DRAWINGS

FIG. 1 is a schematic cross-sectional view illustrating an example of a configuration of a magnetic recording medium according to a first embodiment of the present technology.

FIGS. 2A and 2B are schematic cross-sectional views illustrating examples of a configuration of a magnetic recording medium according to a modification example of the first embodiment of the present technology.

FIG. 3A is a schematic cross-sectional view illustrating an example of a configuration of a display according to a second embodiment of the present technology. FIG. 3B is an enlarged cross-sectional view of a part of FIG. 3A.

### MODE FOR CARRYING OUT THE INVENTION

Embodiments of present technology will be described in the following order.

1 First Embodiment (example of magnetic recording medium)

1.1 Configuration of magnetic recording medium

1.2 Method for manufacturing magnetic recording medium

1.3 Effect

1.4 Modification Example

2 Second embodiment (example of display)

2.1 Configuration of display

2.2 Effect

2.3 Modification Example

### 1 First Embodiment

[1.1 Configuration of Magnetic Recording Medium]

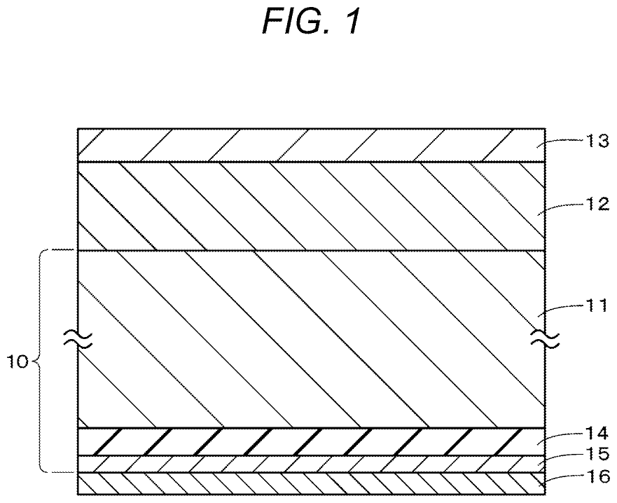

A magnetic recording medium according to a first embodiment of the present technology is a so-called coating type perpendicular magnetic recording medium, and as illustrated in FIG. 1, includes an elongated substrate 11, a base layer 12 disposed on one surface of the substrate 11, a recording layer 13 disposed on the base layer 12, a reinforcing layer 14 disposed on the other surface of the substrate 11, a cupping suppressing layer 15 disposed on the reinforcing layer 14, and a back layer 16 disposed on the cupping suppressing layer 15. Furthermore, the magnetic recording medium may further include a protective layer, a lubricant layer, and the like disposed on the recording layer 13, if necessary. The substrate 11, the reinforcing layer 14, and the cupping suppressing layer 15 constitute a laminate 10.

The magnetic recording medium has an elongated shape. The magnetic recording medium preferably has a Young's modulus in a longitudinal direction of 7 GPa or more and 14 GPa or less. When the Young's modulus is 7 GPa or more, a favorable magnetic head contact can be obtained, and edge damage can be suppressed. Meanwhile, when the Young's modulus is 14 GPa or less, a favorable magnetic head contact can be obtained.

The magnetic recording medium preferably has a humidity expansion coefficient of 0.5 ppm/% RH or more and 4 ppm/% RH or less. When the humidity expansion coefficient is within the above range, dimensional stability of the magnetic recording medium can be further improved.

(Substrate)

The substrate 11 is a so-called non-magnetic support, and is specifically a flexible elongated film. The substrate 11 has a thickness of 10 μm or less, for example. The substrate 11 contains, for example, at least one of polyesters, polyolefins, cellulose derivatives, vinyl-based resins, polyimides, polyamides, and polycarbonate. Note that the substrate 11 may have a single layer structure or a laminated structure.

(Base Layer)

The base layer 12 is a nonmagnetic layer containing a nonmagnetic powder and a binder. The base layer 12 may further contain various additives such as conductive particles, a lubricant, an abrasive, a curing agent, and a rust inhibitor, if necessary.

The nonmagnetic powder may be an inorganic substance or an organic substance. Furthermore, carbon black or the like can also be used. Examples of the inorganic substance include a metal, a metal oxide, a metal carbonate, a metal sulfate, a metal nitride, a metal carbide, a metal sulfide, and the like. Examples of the shape of the nonmagnetic powder include various shapes such as an acicular shape, a spherical shape, and a plate shape, but are not limited thereto.

As the binder, a resin having a structure in which a crosslinking reaction is imparted to a polyurethane-based resin, a vinyl chloride-based resin, or the like is preferable. However, the binder is not limited to these resins, and other resins may be blended appropriately according to physical properties and the like required for the magnetic recording medium. Usually, a resin to be blended is not particularly limited as long as being generally used in a coating type magnetic recording medium.

Examples of the resin to be blended include polyvinyl chloride, polyvinyl acetate, a vinyl chloride-vinyl acetate copolymer, a vinyl chloride-vinylidene chloride copolymer, a vinyl chloride-acrylonitrile copolymer, an acrylate-acrylonitrile copolymer, an acrylate-vinyl chloride-vinylidene chloride copolymer, a vinyl chloride-acrylonitrile copolymer, an acrylate-acrylonitrile copolymer, an acrylate-vinylidene chloride copolymer, a methacrylate-vinylidene chloride copolymer, a methacrylate-vinyl chloride copolymer, a methacrylate-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, and nitrocellulose), a styrene-butadiene copolymer, a polyester resin, an amino resin, a synthetic rubber, and the like.

Furthermore, examples of a thermosetting resin or a reactive resin include a phenol resin, an epoxy resin, a urea resin, a melamine resin, an alkyd resin, a silicone resin, a polyamine resin, a urea formaldehyde resin, and the like.

Furthermore, in order to improve dispersibility of a magnetic powder, a polar functional group such as —SO₃M, —OSO₃M, —COOM, or P═O(OM)₂ may be introduced into each of the above-described binders. Here, in the formulas, M represents a hydrogen atom or an alkali metal such as lithium, potassium, or sodium.

Moreover, examples of the polar functional group include a side chain type group having a terminal group of —NR1R2 or —NR1R2R3⁺X⁻, and a main chain type group of >NR1R2⁺X⁻. Here, in the formulas, R1, R2, and R3 each represent a hydrogen atom or a hydrocarbon group, and X⁻ represents an ion of a halogen element such as fluorine, chlorine, bromine, or iodine, or an inorganic or organic ion. Furthermore, examples of the polar functional group include —OH, —SH, —CN, an epoxy group, and the like.

Furthermore, a polyisocyanate may be used in combination with a resin to crosslink and harden the polyisocyanate. Examples of the polyisocyanate include toluene diisocyanate and an adduct thereof, alkylene diisocyanate and an adduct thereof, and the like.

As the conductive particles, fine particles mainly containing carbon, for example, carbon black can be used. Examples of the carbon black include Asahi #15, #15HS, and the like manufactured by Asahi Carbon Co., Ltd. Furthermore, hybrid carbon in which carbon is attached to surfaces of silica particles may be used.

As the lubricant, for example, an ester of a monobasic fatty acid having 10 to 24 carbon atoms and any one of monohydric to hexahydric alcohols each having 2 to 12 carbon atoms, a mixed ester thereof, or a di- or tri-fatty acid ester can be used appropriately. Specific examples of the lubricant include lauric acid, myristic acid, palmitic acid, stearic acid, behenic acid, oleic acid, linoleic acid, linolenic acid, elaidic acid, butyl stearate, pentyl stearate, heptyl stearate, octyl stearate, isooctyl stearate, octyl myristate, and the like.

As the abrasive, for example, α-alumina having an a conversion ratio of 90% or more, β-alumina, γ-alumina, silicon carbide, chromium oxide, cerium oxide, α-iron oxide, corundum, silicon nitride, titanium carbide, titanium oxide, silicon dioxide, tin oxide, magnesium oxide, tungsten oxide, zirconium oxide, boron nitride, zinc oxide, calcium carbonate, calcium sulfate, barium sulfate, molybdenum disulfide, acicular a iron oxide obtained by dehydrating and annealing a raw material of magnetic iron oxide, a product obtained by surface treatment thereof with aluminum and/or silica if necessary, and the like are used singly or in combination thereof.

(Recording Layer)

The recording layer 13 is, for example, a perpendicular recording layer capable of short wavelength recording or ultra-short wavelength super recording. The recording layer 13 is a magnetic layer having magnetic anisotropy in a thickness direction of the recording layer 13. In other words, an easily magnetizable axis of the recording layer 13 is oriented in a thickness direction of the recording layer 13. The recording layer 13 has an average thickness preferably of 30 nm or more and 100 nm or less, more preferably of 50 nm or more and 70 nm or less.

The recording layer 13 is, for example, a magnetic layer containing a magnetic powder and a binder. The recording layer 13 may further contain various additives such as conductive particles, a lubricant, an abrasive, a curing agent, and a rust inhibitor, if necessary.

The magnetic powder is, for example, a hexagonal ferrite magnetic powder or a cubic ferrite magnetic powder. The hexagonal ferrite magnetic powder is constituted by magnetic particles of an iron oxide having hexagonal ferrite as a main phase (hereinafter referred to as “hexagonal ferrite magnetic particles”). The hexagonal ferrite contains, for example, at least one selected from the group consisting of Ba, Sr, Pb, and Ca. The hexagonal ferrite is preferably barium ferrite containing Ba. In addition to Ba, the barium ferrite may further contain at least one selected from the group consisting of Sr, Pb, and Ca.

More specifically, the hexagonal ferrite has an average composition represented by a general formula MFe₁₂O₁₉. However, M represents, for example, at least one metal selected from the group consisting of Ba, Sr, Pb, and Ca. M preferably represents Ba. M may be a combination of Ba and at least one metal selected from the group consisting of Sr, Pb, and Ca. In the above general formula, a part of Fe may be replaced with another metal element.

The hexagonal ferrite magnetic particles have an average particle diameter (average plate diameter) preferably of 32 nm or less, more preferably of 15 nm or more and 32 nm or less. The hexagonal ferrite magnetic particles have an average particle thickness preferably of 9 nm or less, more preferably of 7 nm or more and 9 nm or less. The hexagonal ferrite magnetic particles have an average aspect ratio (average particle diameter/average particle thickness) preferably of 3.9 or less, more preferably of 1.9 or more and 3.9 or less.

The cubic ferrite magnetic powder is constituted by magnetic particles of an iron oxide having cubic ferrite as a main phase (hereinafter referred to as “cubic ferrite magnetic particles”). The cubic ferrite contains at least one selected from the group consisting of Co, Ni, Mn, Al, Cu, and Zn. Preferably, the cubic ferrite contains at least Co, and further contains, in addition to Co, at least one selected from the group consisting of Ni, Mn, Al, Cu, and Zn. More specifically, for example, the cubic ferrite has an average composition represented by a general formula MFe₂O₄. However, M represents at least one metal selected from the group consisting of Co, Ni, Mn, Al, Cu, and Zn. Preferably, M represents a combination of Co and at least one metal selected from the group consisting of Ni, Mn, Al, Cu, and Zn.

The cubic ferrite magnetic particles have an average plate diameter (average particle size) preferably of 14 nm or less, more preferably of 10 nm or more and 14 nm or less. The cubic ferrite magnetic particles preferably have an average plate ratio (average aspect ratio (average plate diameter L_{AM}/average plate thickness L_{BM})) of 0.75 or more and 1.25 or less.

The binder is similar to that in the above-described base layer 12. The conductive particles, the lubricant, and the abrasive are also similar to those of the above-described base layer 12.

As nonmagnetic reinforcing particles, the recording layer 13 may further contain aluminum oxide (α, β, or γ alumina), chromium oxide, silicon oxide, diamond, garnet, emery, boron nitride, titanium carbide, silicon carbide, titanium carbide, titanium oxide (rutile type or anatase type titanium oxide), and the like.

(Reinforcing Layer)

The reinforcing layer 14 is for enhancing mechanical strength of the magnetic recording medium to obtain excellent dimensional stability. The reinforcing layer 14 contains, for example, at least one of a metal and a metal compound. Here, it is defined that the metal includes a semimetal. The metal is, for example, at least one of aluminum and copper, and preferably copper. This is because copper is inexpensive and has a relatively low vapor pressure, and therefore can form the reinforcing layer 14 at low cost. The metal may be, for example, at least one of aluminum, copper, silicon, and cobalt. The metal compound is, for example, a metal oxide. The metal oxide is, for example, at least one of aluminum oxide, copper oxide, and silicon oxide, and preferably copper oxide. This is because the reinforcing layer 14 can be formed at low cost by a vapor deposition method or the like. The metal oxide may be, for example, at least one of aluminum oxide, copper oxide, silicon oxide, and cobalt oxide. The reinforcing layer 14 may be, for example, a vapor-deposited film formed by a vacuum oblique vapor deposition method or a sputtered film formed by a sputtering method.

The reinforcing layer 14 preferably has a laminated structure of two or more layers. As the thickness of the reinforcing layer 14 is increased, expansion and contraction of the substrate 11 against an external force can be further suppressed. However, in a case where the reinforcing layer 14 is formed using a vacuum thin film manufacturing technique such as a vapor deposition method or sputtering, as described above, as the thickness of the reinforcing layer 14 is increased, a gap may be generated more easily in the reinforcing layer 14. By causing the reinforcing layer 14 to have a laminated structure of two or more layers as described above, when the reinforcing layer 14 is formed using the vacuum thin film manufacturing technique, a gap generated in the reinforcing layer 14 can be suppressed, and denseness of the reinforcing layer 14 can be improved. As a result, water vapor transmittance of the reinforcing layer 14 can be reduced. Therefore, expansion of the substrate 11 can be further suppressed, and dimensional stability of the magnetic recording medium can be further improved. In a case where the reinforcing layer 14 has a laminated structure of two or more layers, materials of the layers may be the same as or different from each other.

The reinforcing layer 14 preferably has an average thickness of 150 nm or more and 500 nm or less. When the average thickness of the reinforcing layer 14 is 150 nm or more, a favorable function (that is, favorable dimensional stability of the magnetic recording medium) is obtained as the reinforcing layer 14. Meanwhile, even if the average thickness of the reinforcing layer 14 is not larger than 500 nm, a sufficient function as the reinforcing layer 14 is obtained. Furthermore, if the average thickness of the reinforcing layer 14 is more than 500 nm, in order to suppress occurrence of cupping, the average thickness of the cupping suppressing layer 15 needs to be large, and the total thickness of the reinforcing layer 14 and the cupping suppressing layer 15 may be too large.

The average thickness of the reinforcing layer 14 is determined as follows. First, the magnetic recording medium is cut perpendicularly to a main surface thereof, and a cross section thereof is observed with a transmission electron microscope (TEM).

Measurement conditions of TEM are illustrated below.

Apparatus: TEM (H9000NAR, manufactured by Hitachi, Ltd.)

Acceleration voltage: 300 kV

Magnification: 100000 times

Next, the average thickness of the reinforcing layer 14 is calculated from the observed TEM image. Specifically, a histogram is made using a SEM/TEM measuring software, Image Measuring Tool manufactured by the General Materials Science and Technology Promotion Foundation, and the average thickness of the reinforcing layer 14 is calculated.

In a case where an average thickness of the reinforcing layer 14 is 150 nm or more and 500 nm or less, a ratio (D2/D1) of an average thickness D2 of the cupping suppressing layer 15 to an average thickness D1 of the reinforcing layer 14 is preferably 0.05 or more and 0.7 or less. When the ratio (D2/D1) is 0.05 or more, the average thickness D2 of the cupping suppressing layer 15 is sufficiently large with respect to the average thickness D1 of the reinforcing layer 14. Therefore, an effect of suppressing cupping can be improved. Meanwhile, when the ratio (D2/D1) is 0.7 or less, the average thickness D2 of the cupping suppressing layer 15 is not too large with respect to the average thickness D1 of the reinforcing layer 14. Therefore, an effect of suppressing cupping can be improved.

(Cupping Suppressing Layer)

The cupping suppressing layer 15 is for suppressing cupping generated by forming the reinforcing layer 14 on the substrate 11. Here, cupping means curvature generated in a width direction of the elongated substrate 11. A tensile stress as an internal stress, that is, a stress to deform a back surface side of the substrate 11 into a recessed shape acts on the reinforcing layer 14. Meanwhile, a compressive stress as internal stress, that is, a stress to deform a back surface side of the substrate 11 into a protruding shape acts on the cupping suppressing layer 15. As a result, the internal stresses of the reinforcing layer 14 and the cupping suppressing layer 15 cancel out each other, and occurrence of cupping in the magnetic recording medium can be suppressed.

The cupping suppressing layer 15 is, for example a carbon thin film. The carbon thin film is preferably a hard carbon thin film containing diamond-like carbon (hereinafter referred to as “DLC”). The cupping suppressing layer 15 may be, for example, a chemical vapor deposition (CVD) film formed by a CVD method or a sputtered film formed by a sputtering method.

The cupping suppressing layer 15 preferably has a laminated structure of two or more layers. This is because dimensional stability of the magnetic recording medium can be further improved. Note that the principle thereof is similar to the case where the reinforcing layer 14 has a laminated structure of two or more layers. In the case where the cupping suppressing layer 15 has a laminated structure of two or more layers, materials of the layers may be the same as or different from each other.

The cupping suppressing layer 15 preferably has an average thickness of 10 nm or more and 200 nm or less. When the average thickness of the cupping suppressing layer 15 is less than 10 nm, a compressive stress of the cupping suppressing layer 15 may be too small. Meanwhile, when the average thickness of the cupping suppressing layer 15 exceeds 200 nm, the compressive stress of the cupping suppressing layer 15 may be too large. Note that the average thickness of the cupping suppressing layer 15 can be determined in a similar manner to the above-described method for calculating the average thickness of the reinforcing layer 14.

(Back Layer)

The back layer 16 contains a binder, inorganic particles, and a lubricant. The back layer 16 may contain various additives such as a curing agent and an antistatic agent, if necessary. The binder, the inorganic particles, and the lubricant are similar to those of the base layer 12 described above.

[1.2 Method for Manufacturing Magnetic Recording Medium]

Next, an example of a method for manufacturing the magnetic recording medium having the above-described configuration will be described.

(Step of Adjusting Coating Material)

First, by kneading and dispersing a nonmagnetic powder, a binder, and the like in a solvent, a base layer-forming coating material is prepared. Next, by kneading and dispersing a magnetic powder, a binder, and the like in a solvent, a recording layer-forming coating material is prepared. Next, by kneading and dispersing a binder, inorganic particles, a lubricant, and the like in a solvent, a back layer-forming coating material is prepared. For example, the following solvents, dispersing apparatuses, and kneading apparatuses can be applied to preparation of the base layer-forming coating material, the recording layer-forming coating material, and the back layer-forming coating material.

Examples of the solvent used for preparing the above-described coating material include ketone-based solvents such as acetone, methyl ethyl ketone, methyl isobutyl ketone, and cyclohexanone, alcohol-based solvents such as methanol, ethanol, and propanol, ester-based solvents such as methyl acetate, ethyl acetate, butyl acetate, propyl acetate, ethyl lactate, and ethylene glycol acetate, ether-based solvents such as diethylene glycol dimethyl ether, 2-ethoxyethanol, tetrahydrofuran, and dioxane, aromatic hydrocarbon-based solvents such as benzene, toluene, and xylene, and halogenated hydrocarbon-based solvents such as methylene chloride, ethylene chloride, carbon tetrachloride, chloroform, and chlorobenzene. These solvents may be used singly, or may be used in a mixture thereof appropriately.

Examples of the kneading apparatus used for preparing the above-described coating material include a continuous twin-screw kneading machine, a continuous twin-screw kneading machine capable of performing dilution in multiple stages, a kneader, a pressure kneader, a roll kneader, and the like, but are not particularly limited to these apparatuses. Furthermore, examples of the dispersing apparatus used for preparing the above-described coating material include a roll mill, a ball mill, a horizontal sand mill, a vertical sand mill, a spike mill, a pin mill, a tower mill, a pearl mill (for example, “DCP mill” manufactured by Eirich Co., Ltd.), a homogenizer, and an ultrasonic wave dispersing machine, but are not particularly limited to these apparatuses.

(Step of Forming Reinforcing Layer)

Next, the reinforcing layer 14 is formed on the other surface of the substrate 11 using a roll-to-roll type vacuum film forming apparatus. The average thickness of the reinforcing layer 14 can be adjusted by changing film forming conditions such as a winding speed of the substrate 11, a flow rate of an introduced gas, and a discharge voltage. Examples of a vacuum film forming apparatus include a vapor deposition apparatus (for example, oblique vapor deposition apparatus), a sputtering apparatus, a CVD apparatus, and the like.

(Step of Forming Cupping Suppressing Layer)

Next, the cupping suppressing layer 15 is formed on the reinforcing layer 14 using a roll-to-roll type vacuum film forming apparatus. The average thickness of the cupping suppressing layer 15 can be adjusted by changing film forming conditions such as a winding speed of the substrate 11, a flow rate of an introduced gas, and a discharge voltage. Examples of a vacuum film forming apparatus include a vapor deposition apparatus, a sputtering apparatus, a CVD apparatus, and the like. In this way, the laminate 10 is obtained.

(Step of Forming Base Layer)

Next, by applying a base layer-forming coating material onto one surface of the substrate 11 and drying the base layer-forming coating material, the base layer 12 is formed on one surface of the substrate 11.

(Step of Forming Recording Layer)

Next, by applying a recording layer-forming coating material onto the base layer 12 and drying the recording layer-forming coating material, the recording layer 13 is formed on the base layer 12. Note that by causing magnetic field orientation of a magnetic powder contained in the coating material during drying, if necessary, an easily magnetizable axis of the magnetic powder may be oriented in a thickness direction of the recording layer 13.

(Step of Heat Treatment)

Next, if necessary, the substrate 11 on which the above layers are laminated may be subjected to a heat treatment to thermally shrink the substrate 11. By thermally shrink the substrate 11 in this way, cupping can be further suppressed. A temperature for the heat treatment is, for example, 80° C. or higher and 120° C. or lower. Retention time of the heat treatment is, for example, 3 hours or more and 72 hours or less.

(Step of Forming Back Layer)

Next, by applying a back layer-forming coating material onto the cupping suppressing layer 15 and drying the back layer-forming coating material, the back layer 16 is formed. As a result, a wide magnetic recording medium is obtained. Note that after the step of forming the recording layer 13 (or after the step of heat treatment) and before the step of forming the back layer 16, wettability of a surface of the cupping suppressing layer 15 is preferably improved by a surface modification treatment. This is because coatability of the back layer-forming coating material can be improved. Examples of the surface modification treatment include a corona discharge treatment, a plasma treatment, a UV ozone treatment, an electron beam treatment, and the like.

(Step of Calendering Treatment and Cutting)

Next, the obtained wide magnetic recording medium is rewound around a large-diameter core and cured. Next, the wide magnetic recording medium is calendered and then cut into a predetermined width. As a result, a target magnetic recording medium is obtained. Note that the step of forming the back layer 16 may be performed after the calendering treatment.

[1.3 Effect]

The magnetic recording medium according to the first embodiment of present technology includes the reinforcing layer 14 disposed on the other surface of the substrate 11 and the cupping suppressing layer 15 disposed on the reinforcing layer 14. As a result, the internal stresses of the reinforcing layer 14 and the cupping suppressing layer 15 cancel out each other, and occurrence of cupping in the magnetic recording medium can be suppressed. As a result, it is possible to provide a high SN magnetic recording medium with excellent off-track characteristics, capable of keeping a contact state between a magnetic head and the magnetic recording medium in a favorable state and having high dimensional stability in a track width direction.

[1.4 Modification Example]

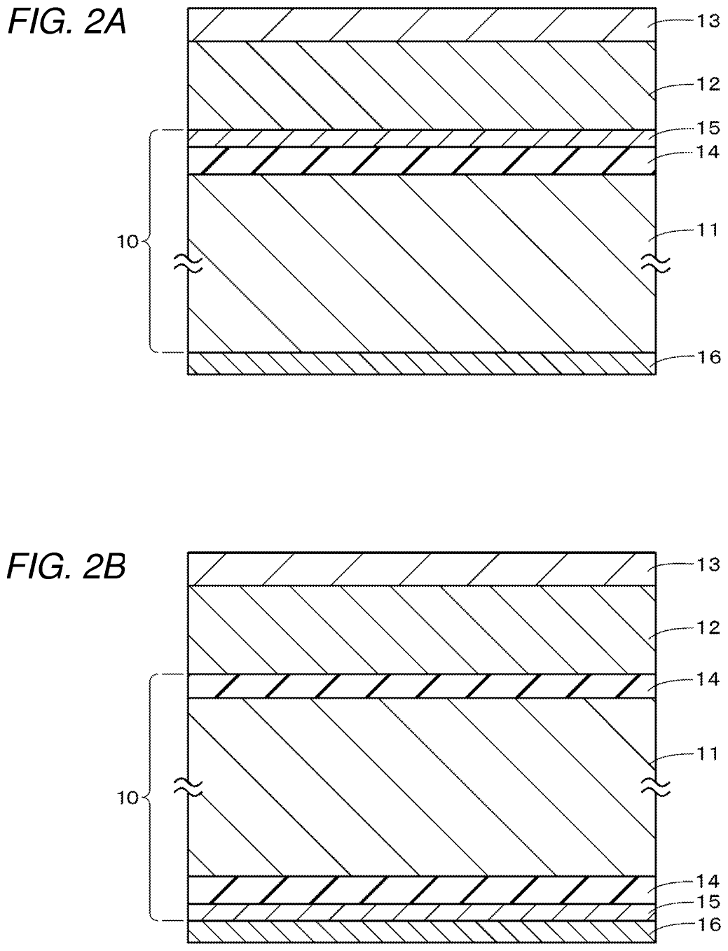

Instead of including the reinforcing layer 14 and the cupping suppressing layer 15 on the other surface of the substrate 11 (a surface on the opposite side to the recording layer 13 side), as illustrated in FIG. 2A, the magnetic recording medium may include the reinforcing layer 14 and the cupping suppressing layer 15 on one surface of the substrate 11 (a surface on the recording layer 13 side).

As illustrated in FIG. 2B, the magnetic recording medium may include the reinforcing layers 14 on both surfaces of the substrate 11. In this case, the cupping suppressing layer 15 is disposed on a side of one of the reinforcing layers 14 disposed on both surfaces, having a larger internal stress.

The reinforcing layer 14 may include a first metal oxide layer, a second metal oxide layer, and a metal layer disposed between the first metal oxide layer and the second metal oxide layer. The first and second metal oxide layers each contain, for example, at least one of aluminum oxide, copper oxide, silicon oxide, and cobalt oxide, preferably copper oxide. The first and second metal oxide layers may contain the same type of metal oxide as or different types of metal oxides from each other. The metal layer contains, for example, at least one of aluminum, copper, silicon, and cobalt, preferably copper.

The reinforcing layer 14 may contain a metal and oxygen and may have a concentration distribution in which an oxygen concentration changes in a thickness direction thereof. The oxygen concentration on a surface on the opposite side to the substrate 11 side (that is, a surface on the cupping suppressing layer 15 side) out of both surfaces of the reinforcing layer 14 is higher than the oxygen concentration inside the reinforcing layer 14. Specifically, the oxygen concentration of the reinforcing layer 14 decreases from the opposite surface to the substrate 11 side toward the inside. In this case, the change in oxygen concentration may be continuous or discontinuous.

The oxygen concentration on a surface on the substrate 11 side out of both surfaces of the reinforcing layer 14 may be higher than the oxygen concentration inside the reinforcing layer 14. This is because in a case where the reinforcing layer 14 is formed using a vacuum thin film manufacturing technique such as a vapor deposition method or sputtering, depending on a material, a surface state, and the like of the substrate 11, as described above, the oxygen concentration on a surface on the substrate 11 side out of both surfaces of the reinforcing layer 14 may be higher than the oxygen concentration inside the reinforcing layer. Specifically, the oxygen concentration of the reinforcing layer 14 decreases from the surface on the base material 11 side toward the inside. In this case, the change in oxygen concentration may be continuous or discontinuous.

The metal contained in the reinforcing layer 14 is, for example, at least one of aluminum, copper, silicon, and cobalt, and preferably copper.

The reinforcing layer 14 having the above concentration distribution can be manufactured, for example, by changing an oxygen concentration contained in a process gas when the reinforcing layer 14 is formed using a vacuum thin film manufacturing technique such as a vapor deposition method or sputtering.

In the above-described first embodiment, the case where the magnetic recording medium is a perpendicular magnetic recording medium has been described as an example, but the magnetic recording medium may be a horizontal magnetic recording medium.

In the above-described first embodiment, the example in which the hexagonal ferrite magnetic powder or the cubic ferrite magnetic powder is used as the magnetic powder contained in the recording layer 13 has been described. However, the magnetic powder is not limited to this example, and a magnetic powder generally used in the perpendicular magnetic recording medium or the horizontal magnetic recording medium can be used. Specific examples of the magnetic powder include a Fe-based metal powder, a Fe—Co-based metal powder, iron carbide, iron oxide, and the like. Note that as an auxiliary element, a metal compound of Co, Ni, Cr, Mn, Mg, Ca, Ba, Sr, Zn, Ti, Mo, Ag, Cu, Na, K, Li, Al, Si, Ge, Ga, Y, Nd, La, Ce, Zr, or the like may coexist.

In the above-described first embodiment, the example in which the base layer 12 and the recording layer 13 are thin films manufactured by a coating step (wet process) has been described. However, the base layer 12 and the recording layer 13 may be thin films manufactured by a vacuum thin film manufacturing technique (dry process) such as sputtering.

In the above-described first embodiment, the configuration in which the reinforcing layer 14 is disposed on the other surface of the substrate 11 and the cupping suppressing layer 15 is disposed on the reinforcing layer 14 has been described as an example. However, the cupping suppressing layer 15 may be disposed on the other surface of the substrate 11, and the reinforcing layer 14 may be disposed on the reinforcing layer 14. However, in a case where a DLC layer is used as the cupping suppressing layer 15, it may be difficult to form the cupping suppressing layer 15 on the substrate 11 depending on a material of the substrate 11, and therefore the cupping suppressing layer 15 is preferably disposed on the reinforcing layer 14.

In the above-described first embodiment, the case where the magnetic recording medium includes the base layer and the back layer has been described as an example, but it may also be possible that the magnetic recording medium does not include at least one of the base layer and the back layer.

### 2 Second Embodiment

[2.1 Configuration of Display]

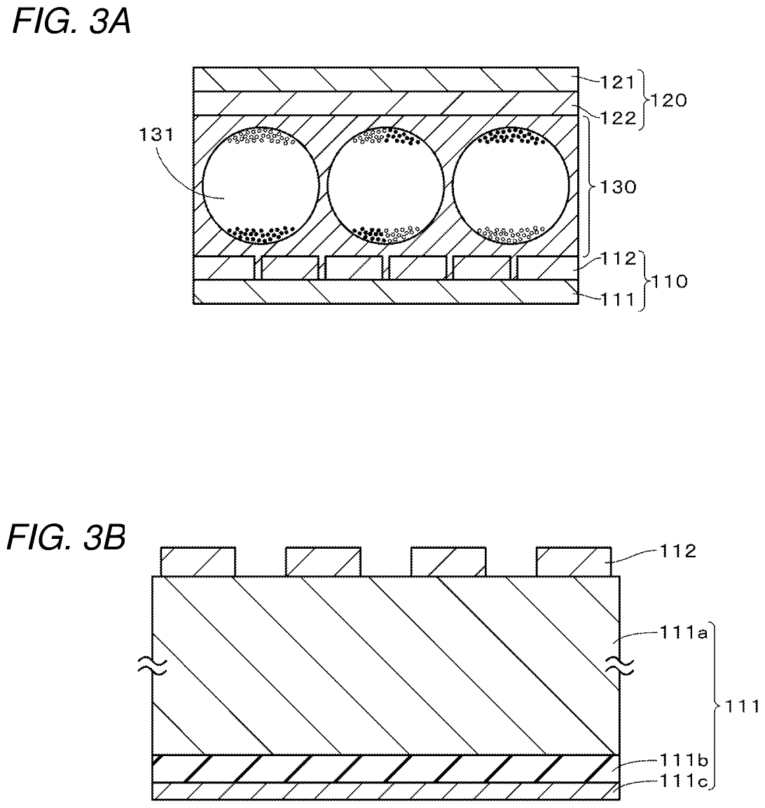

A display according to a second embodiment of the present technology is a flexible microcapsule electrophoretic type electronic paper, and as illustrated in FIG. 3A, includes a first conductive element 110, a second conductive element 120 disposed so as to face the first conductive element 110, and a microcapsule layer (medium layer) 130 disposed between these elements. This display is an example of a flexible device. Here, an example in which the present technology is applied to the microcapsule electrophoretic type electronic paper will be described. However, the electronic paper is not limited to this example. The present technology can also be applied to an electronic paper of a twist ball type, a thermal rewritable type, a toner display type, an in-plane electrophoretic type, an electronic powder type, or the like. Furthermore, the present technology can also be applied to a liquid crystal display, an organic electro luminescence (EL) display, and the like.

(Microcapsule Layer)

The microcapsule layer 130 includes a plurality of microcapsules 131. In each of the microcapsules 131, for example, a transparent liquid (dispersion medium) in which black particles and white particles are dispersed is enclosed.

(First and Second Conductive Elements)

The first conductive element 110 includes a laminate 111 and an electrode 112 disposed on one surface of the laminate 111. The second conductive element 120 includes a laminate 121 and an electrode 122 disposed on one surface of the laminate 121. The first and second conductive elements 110 and 120 are disposed so as to be separated from each other by a predetermined distance such that the electrodes 112 and 122 face each other.

The electrodes 112 and 122 are each formed in a predetermined electrode pattern shape according to a driving method of the display. Examples of the driving method include a simple matrix driving method, an active matrix driving method, a segment driving method, and the like.

As illustrated in FIG. 3B, the laminate 111 includes a substrate 111a, a reinforcing layer 111b disposed on the other surface of the substrate 111a, and a curvature suppressing layer 111c disposed on the reinforcing layer 111b. The substrate 111a, the reinforcing layer 111b, and the curvature suppressing layer 111c may be transparent or opaque to visible light.

The substrate 111a has a film shape. Here, the film also includes a sheet. The substrate 111a preferably has a thickness of 10 μm or less. This is because the thickness of the substrate 111a of 10 μm or less makes an effect obtained by including the reinforcing layer 111b and the curvature suppressing layer 111c remarkable. For a material of the substrate 111a, for example, a polymer resin can be used. As the polymer resin, for example, at least one of polyethylene terephthalate (PET), polyethylene naphthalate (PEN), polycarbonate (PC), an acrylic resin (PMMA), polyimide (PI), triacetylcellulose (TAC), polyester, polyamide (PA) aramid, polyethylene (PE), polyacrylate, polyether sulfone, polysulfone, polypropylene (PP), diacetyl cellulose, polyvinyl chloride, an epoxy resin, a urea resin, a urethane resin, a melamine resin, a cyclic olefin polymer (COP), and a norbornene-based thermoplastic resin can be used.

The reinforcing layer 111b and the curvature suppressing layer 111c are similar to the reinforcing layer 14 and the cupping suppressing layer 15 in the first embodiment, respectively.

The first conductive element 110 on a side on which the curvature suppressing layer 111c is disposed preferably has surface resistance of 0.4Ω/□ or less. Here, the surface resistance is a value measured by a four-terminal method.

The laminate 111 preferably has a humidity expansion coefficient of 0.5 ppm/% RH or more and 4 ppm/% RH or less. When the humidity expansion coefficient is within the above range, dimensional stability of the first conductive element 110 can be further improved.

The laminate 121 has a similar configuration to the laminate 111, and therefore description thereof will be omitted. However, as the substrate, the reinforcing layer, and the curvature suppressing layer included in the laminate 121, those having transparency to visible light are used.

[2.2 Effect]

The display according to the second embodiment includes the first and second conductive elements 110 and 120 disposed such that the electrodes 112 and 122 face each other. The first conductive element 110 includes the reinforcing layer 111b and the curvature suppressing layer 111c on the other surface of the substrate 111a. Therefore, the internal stresses of the reinforcing layer 11b and the curvature suppressing layer 111c cancel out each other, and occurrence of curvature in the first conductive element can be suppressed. As a result, the first conductive element 110 having excellent dimensional stability and capable of suppressing curvature is obtained. In other words, shape stability of the first conductive element 110 can be improved. The second conductive element 120 also has a similar configuration to the first conductive element 110, and therefore shape stability of the second conductive element 120 can also be improved. As a result, even in a case where the electrodes 112 and 122 are highly integrated, deterioration of overlapping accuracy between patterns of the electrodes 112 and 122 can be suppressed. Therefore, it is possible to provide a high-quality display.

[2.3 Modification Example]

In the above-described second embodiment, the example in which the present technology is applied to the display and the first and second conductive elements 110 and 120 included in the display has been described, but the present technology is not limited thereto. The present technology is also applicable, for example, to an electromagnetic shield, a touch panel, and various wearable devices. In a case where the present technology is applied to a touch panel or a wearable device, for example, deterioration of overlapping accuracy between highly integrated electrode patterns or between wiring patterns can be suppressed.

In the above-described second embodiment, the example in which the present technology is applied to the flexible device (flexible display) has been described, but the present technology can also be applied to a non-flexible device.

Instead of including the reinforcing layer 111b and the curvature suppressing layer 111c on the other surface of the substrate 111a (a surface on the opposite side to the electrode 112 side), the laminate 111 may include the reinforcing layer 111b and the curvature suppressing layer 111c on one surface of the substrate 111a (a surface on the electrode 112 side). In this case, an insulating layer is disposed between the curvature suppressing layer 111c and the electrode 112. The laminate 121 may have a similar configuration to the laminate 111.

The laminate 111 may include the reinforcing layers 14 on both surfaces of the substrate 11. In this case, the curvature suppressing layer 111c is disposed on a side of one of the reinforcing layers 111b disposed on both surfaces, having a larger internal stress. The laminate 121 may have a similar configuration to the laminate 111.

### EXAMPLES

Hereinafter, the present technology will be specifically described with reference to Examples, but the present technology is not limited only to these Examples.

Note that in the following Examples and Comparative Examples, an average thickness of each of a reinforcing layer and a cupping suppressing layer was determined in a similar manner to the method described in the first embodiment.

The present Examples will be described in the following order.

i Examples and Comparative Examples for magnetic tape

ii Examples for electromagnetic shield

### i Examples and Comparative Examples for Magnetic Tape

### Examples 1 to 14 and 34 to 39

(Step of Preparing Recording Layer-Forming Coating Material)

First, a recording layer-forming coating material was prepared as follows. First, the following raw materials were kneaded with an extruder to obtain a kneaded product.

CoNi ferrite crystal magnetic powder: 100 parts by mass

(Shape: substantially cubic shape, average plate diameter: 11 nm, average plate ratio: 0.95)

Vinyl chloride-based resin (cyclohexanone solution 30% by mass): 55.6 parts by mass

(Degree of polymerization: 300, Mn=10000, OSO₃K=0.07 mmol/g and secondary OH=0.3 mmol/g were contained as polar groups)

Aluminum oxide powder: 5 parts by mass

(α-Al₂O₃, average particle diameter: 0.2 μm) Carbon black: 2 parts by mass

(Manufactured by Tokai Carbon Co., Ltd., trade name: Seast TA)

Next, the kneaded product and the following raw materials were put in a stirring tank equipped with a disper, and were premixed. Thereafter, the mixture was further subjected to sand mill mixing, and was subjected to a filter treatment to prepare a recording layer-forming coating material.

Vinyl chloride-based resin: 27.8 parts by mass

(Resin solution: resin content 30% by mass, cyclohexanone 70% by mass)

Polyisocyanate: 4 parts by mass

(Trade name: Coronate L, manufactured by Nippon Polyurethane Industry Co., Ltd.)

Myristic acid: 2 parts by mass

N-Butyl stearate: 2 parts by mass

Methyl ethyl ketone: 121.3 parts by mass

Toluene: 121.3 parts by mass

Cyclohexanone: 60.7 parts by mass

(Step of Preparing Base Layer-Forming Coating Material)

Next, a base layer-forming coating material was prepared as follows. First, the following raw materials were kneaded with an extruder to obtain a kneaded product.

Acicular iron oxide powder: 100 parts by mass

(α-Fe₂O₃, average long axis length 0.15 μm)

Vinyl chloride-based resin: 55.6 parts by mass

(Resin solution: resin content 30% by mass, cyclohexanone 70% by mass)

Carbon black: 10 parts by mass

(Average particle diameter 20 nm)

Next, the kneaded product and the following raw materials were put in a stirring tank equipped with a disper, and were premixed. Thereafter, the mixture was further subjected to sand mill mixing, and was subjected to a filter treatment to prepare a base layer-forming coating material.

Polyurethane-based resin UR8200 (manufactured by Toyobo Co., Ltd.): 18.5 parts by mass

Polyisocyanate: 4 parts by mass

(Trade name: Coronate L, manufactured by Nippon Polyurethane Industry Co., Ltd.)

Myristic acid: 2 parts by mass

N-Butyl stearate: 2 parts by mass

Methyl ethyl ketone: 108.2 parts by mass

Toluene: 108.2 parts by mass

Cyclohexanone: 18.5 parts by mass

(Step of Preparing Back Layer-Forming Coating Material)

Next, a backing layer-forming coating material was prepared as follows. The following raw materials were mixed in a stirring tank equipped with a disper, and were subjected to a filter treatment to prepare a back layer-forming coating material.

Carbon black (manufactured by Asahi Corporation, trade name: #80): 100 parts by mass

Polyester polyurethane: 100 parts by mass

(Trade name: N-2304, manufactured by Nippon Polyurethane Industry Co., Ltd.)

Methyl ethyl ketone: 500 parts by mass

Toluene: 400 parts by mass

Cyclohexanone: 100 parts by mass

(Step of Forming Reinforcing Layer)

Next, a single Cu layer (reinforcing layer) was formed on one surface of a belt-shaped PEN film (substrate) having a thickness of 6.2 μm using a roll-to-roll type vacuum vapor deposition apparatus. At this time, as illustrated in Tables 1 and 3, an average thickness of the Cu layer was set by adjusting film forming conditions such as a film winding speed.

(Step of Forming Cupping Suppressing Layer)

Next, a DLC layer (cupping suppressing layer) was formed on the Cu layer using a roll-to-roll type CVD apparatus. At this time, the average thickness of the DLC layer was set as illustrated in Tables 1 and 3 by adjusting film forming conditions such as a film winding speed, a flow rate of an introduced gas, and a discharge voltage.

(Step of Forming Base Layer)

Next, by applying a base layer-forming coating material onto the other surface of the PEN film and drying the base layer-forming coating material, a base layer having a thickness of 1 μm was formed on the other surface of the PEN film.

(Step of Forming Recording Layer)

Next, by applying a recording layer-forming coating material onto the base layer and drying the recording layer-forming coating material, a recording layer having a thickness of 70 nm was formed on the base layer.

(Step of Heat Treatment)

Next, the obtained wide magnetic tape was subjected to a heat treatment. The temperature of the heat treatment was adjusted as illustrated in Tables 1 and 3.

(Step of Forming Back Layer)

Next, wettability of a surface of the DLC layer was improved by surface modification. Thereafter, a back layer-forming coating material was applied onto the DLC layer and dried to form a back layer having a thickness of 0.6 μm on the DLC layer. As a result, a wide magnetic tape was obtained.

(Step of Calendering Treatment and Cutting)

Next, a magnetic tape was calendered with a metal roll to smoothen a surface of the recording layer. Next, the wide magnetic tape was cut into a width of ½ inches (12.65 mm) to obtain a target magnetic tape.

### Examples 15 to 28, 40, and 41

A magnetic tape was obtained in a similar manner to Example 1 except that the reinforcing layer had a two-layer structure and that film forming conditions of the Cu layer and the DLC layer were adjusted such that the average thicknesses of the Cu layer and the DLC layer were the values illustrated in Tables 1 and 3.

### Example 29

A magnetic tape was obtained in a similar manner to Example 11 except that a single Al layer was formed instead of the single Cu layer as the reinforcing layer.

### Example 30

A magnetic tape was obtained in a similar manner to Example 25 except that two Al layers were formed instead of the single Cu layer as the reinforcing layer.

### Example 31

A magnetic tape was obtained in a similar manner to Example 11 except that a SiO₂ layer was formed instead of the Cu layer as the reinforcing layer.

### Example 32

A magnetic tape was obtained in a similar manner to Example 11 except that a CuO layer was formed by introducing oxygen during vapor deposition.

### Example 33

A magnetic tape was obtained in a similar manner to Example 29 except that an Al₂O₃ layer was formed by introducing oxygen during vapor deposition.

### Example 42

A magnetic tape was obtained in a similar manner to Example 1 except that the step of the heat treatment for the magnetic tape was omitted.

### Comparative Example 1

A magnetic tape was obtained in a similar manner to Example 3 except that formation of the DLC layer was omitted.

[Evaluation]

The magnetic tapes in Examples 1 to 42 and Comparative Example 1 obtained as described above were evaluated as follows.

(Young's Modulus)

First, a Young's modulus of a magnetic tape was measured using a tensile tester (TCM-200CR manufactured by MNB Co., Ltd.) under an environment of a temperature of 23° C. and a relative humidity of 60%.

(Adhesion Strength of Vapor-Deposited Film)

Adhesion strength of a vapor-deposited film (reinforcing layer) was measured according to a method of LTO standard Ultrium Generation 6 Specification Document U-616 Section 9.8.1. Next, judgement was performed according to the following criteria based on the measurement result.

∘: No peeling occurred

x: Peeling occurred

(Humidity Expansion Coefficient)

In a case where a thermostatic chamber was changed from environmental condition 1 (temperature 16° C., relative humidity 10%) to environmental condition 2 (temperature 29° C., relative humidity 80%), a dimensional change was measured using a laser displacement meter LS-7000 manufactured by Keyence Corporation. Next, a humidity expansion coefficient was determined by the following formula.

TDS (humidity) [ppm]=((tape width at temperature of 29° C. and relative humidity of 80%)−(tape width at temperature of 16° C. and relative humidity of 10%))/(tape width at temperature of 16° C. and relative humidity of 10%)

Humidity expansion coefficient [ppm/% RH]=TDS (humidity)/(80−10)

(Cupping)

Using a cupping measuring apparatus, a tape of 1 m after slitting was allowed to stand for 24 hours in an environment of a temperature of 23° C. and a relative humidity of 60%, and then the amount of cupping was measured. With the recording layer facing upward, the amount of cupping was measured by regarding cupping where the recording layer side was protruding as minus (−) and regarding cupping where the back layer side was protruding as plus (+), and judgement was performed according to the following criteria.

⊙: The amount of cupping is within a range of 0.0 to −0.5 mm

∘: The amount of cupping is within a range of −0.5 to −1.0 mm

Δ: The amount of cupping is within a range of −1.0 to −1.5 mm

x: The amount of cupping is outside a range of 0.0 to −1.5 mm

Note that the length of a measurement sample was 1±0.1 m.

(Increase in Tape Traveling Friction)

Traveling in a fixed section (10 m in length) was performed 100,000 times using a ½ inch fixed head type drive (LTO5), and judgement was performed according to the following criteria.

∘: Traveling continues with a friction equal to the friction of a reference tape (MSRT)

Δ: Traveling continues, but a friction is higher than the friction of a reference tape (MSRT)

x: Traveling stops

(SNR)

First, SNR was determined by causing a magnetic tape to travel in a commercially available tape traveling system manufactured by Mountain Engineering Co., Ltd., and performing record and reproduction using a magnetic head of a ½ inch fixed head type drive. Next, the determined SNR was judged according to the following criteria.

∘: SNR is within −1.5 dB with respect to a reference tape (MSRT) of LTO5 media

Δ: SNR is more than −1.5 dB and −2.5 dB or less with respect to a reference tape (MSRT) of LTO5 media

x: SNR is more than −2.5 dB with respect to a reference tape (MSRT) of LTO5 media

(Result)

Tables 1 and 2 illustrate the configurations and evaluation results of magnetic tapes in Examples 1 to 28.

TABLE 1

| | Reinforcing layer | | | | | | | | |
|---|---|---|---|---|---|---|---|---|---|
| | | | | Average | Average | Cupping suppressing | | | |
| | | | Average | thickness of | thickness of | layer | | Ratio of | Temperature of |
| | | | total | first | second | | Average | average | roll heat |
| | | Layer | thickness | reinforcing | reinforcing | | thickness | thickness | treatment |
| | Material | structure | D1 (nm) | layer (nm) | layer (nm) | Material | D2 (nm) | D2/D1 | (° C.) |
| Example 1 | Cu | 1 | 150 | 150 | 0 | DLC | 30 | 0.2 | 120 |
| Example 2 | Cu | 1 | 200 | 200 | 0 | DLC | 50 | 0.25 | 120 |
| Example 3 | Cu | 1 | 300 | 300 | 0 | DLC | 20 | 0.07 | 120 |
| Example 4 | Cu | 1 | 300 | 300 | 0 | DLC | 50 | 0.17 | 120 |
| Example 5 | Cu | 1 | 300 | 300 | 0 | DLC | 100 | 0.33 | 120 |
| Example 6 | Cu | 1 | 300 | 300 | 0 | DLC | 200 | 0.67 | 100 |
| Example 7 | Cu | 1 | 300 | 300 | 0 | DLC | 200 | 0.67 | 120 |
| Example 8 | Cu | 1 | 400 | 400 | 0 | DLC | 20 | 0.05 | 120 |
| Example 9 | Cu | 1 | 400 | 400 | 0 | DLC | 50 | 0.13 | 120 |
| Example 10 | Cu | 1 | 400 | 400 | 0 | DLC | 100 | 0.25 | 120 |
| Example 11 | Cu | 1 | 400 | 400 | 0 | DLC | 200 | 0.50 | 100 |
| Example 12 | Cu | 1 | 400 | 400 | 0 | DLC | 200 | 0.50 | 120 |
| Example 13 | Cu | 1 | 500 | 500 | 0 | DLC | 100 | 0.20 | 100 |
| Example 14 | Cu | 1 | 500 | 500 | 0 | DLC | 200 | 0.40 | 120 |
| Example 15 | Cu | 2 | 300 | 150 | 150 | DLC | 20 | 0.07 | 120 |
| Example 16 | Cu | 2 | 300 | 150 | 150 | DLC | 50 | 0.17 | 120 |
| Example 17 | Cu | 2 | 300 | 150 | 150 | DLC | 100 | 0.33 | 120 |
| Example 18 | Cu | 2 | 300 | 150 | 150 | DLC | 200 | 0.67 | 100 |
| Example 19 | Cu | 2 | 300 | 150 | 150 | DLC | 200 | 0.67 | 120 |
| Example 20 | Cu | 2 | 300 | 200 | 100 | DLC | 100 | 0.33 | 120 |
| Example 21 | Cu | 2 | 300 | 200 | 100 | DLC | 200 | 0.67 | 120 |
| Example 22 | Cu | 2 | 400 | 200 | 200 | DLC | 20 | 0.05 | 120 |
| Example 23 | Cu | 2 | 400 | 200 | 200 | DLC | 70 | 0.18 | 120 |
| Example 24 | Cu | 2 | 400 | 200 | 200 | DLC | 100 | 0.25 | 120 |
| Example 25 | Cu | 2 | 400 | 200 | 200 | DLC | 200 | 0.50 | 100 |
| Example 26 | Cu | 2 | 400 | 200 | 200 | DLC | 200 | 0.50 | 120 |
| Example 27 | Cu | 2 | 400 | 300 | 100 | DLC | 100 | 0.25 | 120 |
| Example 28 | Cu | 2 | 400 | 300 | 100 | DLC | 200 | 0.50 | 120 |

TABLE 2

| | Evaluation | | | | | |
|---|---|---|---|---|---|---|
| | | Adhesion | Humidity | | | |
| | | strength of | expansion | | Increase in tape | |
| | Young's modulus | vapor-deposited | coefficient | | traveling | SNR |
| | (Gpa) | film | (ppm/% RH) | Cupping | friction | (190kFCI) |
| Example 1 | 9 | ◯ | 3.8 | ◯ | ◯ | ◯ |
| Example 2 | 11.5 | ◯ | 2.9 | ◯ | ◯ | ◯ |
| Example 3 | 8.1 | ◯ | 2.2 | ◯ | ◯ | ◯ |
| Example 4 | 8.5 | ◯ | 2.1 | ◯ | ◯ | ◯ |
| Example 5 | 9 | ◯ | 2 | ◯ | ◯ | ◯ |
| Example 6 | 11.5 | ◯ | 2 | ◯ | ◯ | ◯ |
| Example 7 | 11.9 | ◯ | 1.8 | ⊙ | ◯ | ◯ |
| Example 8 | 9 | ◯ | 1.6 | ◯ | ◯ | ◯ |
| Example 9 | 8.5 | ◯ | 1.5 | ◯ | ◯ | ◯ |
| Example 10 | 9.1 | ◯ | 1.5 | ⊙ | ◯ | ◯ |
| Example 11 | 11 | ◯ | 1.2 | ⊙ | ◯ | ◯ |
| Example 12 | 10.5 | ◯ | 1.3 | ◯ | ◯ | ◯ |
| Example 13 | 10 | ◯ | 0.8 | ◯ | ◯ | ◯ |
| Example 14 | 11.5 | ◯ | 0.6 | ◯ | ◯ | ◯ |
| Example 15 | 8 | ◯ | 2.3 | ◯ | ◯ | ◯ |
| Example 16 | 8.2 | ◯ | 2.2 | ◯ | ◯ | ◯ |
| Example 17 | 11 | ◯ | 2.1 | ⊙ | ◯ | ◯ |
| Example 18 | 11.5 | ◯ | 2 | ⊙ | ◯ | ◯ |
| Example 19 | 11.9 | ◯ | 2 | ⊙ | ◯ | ◯ |
| Example 20 | 10.5 | ◯ | 1.8 | ◯ | ◯ | ◯ |
| Example 21 | 10.9 | ◯ | 1.9 | ⊙ | ◯ | ◯ |
| Example 22 | 8.8 | ◯ | 1.4 | ◯ | ◯ | ◯ |
| Example 23 | 8.5 | ◯ | 1.4 | ⊙ | ◯ | ◯ |
| Example 24 | 9.3 | ◯ | 1.3 | ⊙ | ◯ | ◯ |
| Example 25 | 11.2 | ◯ | 1.4 | ⊙ | ◯ | ◯ |
| Example 26 | 11 | ◯ | 1.4 | ⊙ | ◯ | ◯ |
| Example 27 | 10 | ◯ | 1.5 | ◯ | ◯ | ◯ |
| Example 28 | 10.2 | ◯ | 1.3 | ◯ | ◯ | ◯ |

Tables 3 and 4 illustrate the configurations and evaluation results of magnetic tapes in Examples 29 to 42 and Comparative Example 1.

TABLE 3

| | Reinforcing layer | | | | | Cupping suppressing | | | Temperature of |
|---|---|---|---|---|---|---|---|---|---|
| | | | | Average | Average | layer | | | roll heat |
| | | | Average | thickness of | thickness of | | Average | Ratio of | treatment, |
| | | | total | first | second | | thickness | average | No heat |
| | | Layer | thickness | reinforcing | reinforcing | | D2 | thickness | treatment |
| | Material | structure | D1 (nm) | layer (nm) | layer (nm) | Material | (nm) | D2/D1 | (° C.) |
| Example 29 | Al | 1 | 400 | 400 | 0 | DLC | 200 | 0.50 | 120 |
| Example 30 | Al | 2 | 400 | 200 | 200 | DLC | 200 | 0.50 | 120 |
| Example 31 | SiO2 | 1 | 400 | 400 | 0 | DLC | 200 | 0.50 | 120 |
| Example 32 | CuO | 1 | 400 | 400 | 0 | DLC | 200 | 0.50 | 120 |
| Example 33 | Al2O3 | 1 | 400 | 400 | 0 | DLC | 200 | 0.50 | 120 |
| Example 34 | Cu | 1 | 130 | 130 | 0 | DLC | 15 | 0.12 | 120 |
| Example 35 | Cu | 1 | 130 | 130 | 0 | DLC | 50 | 0.38 | 120 |
| Example 36 | Cu | 1 | 520 | 520 | 0 | DLC | 200 | 0.38 | 120 |
| Example 37 | Cu | 1 | 600 | 600 | 0 | DLC | 100 | 0.17 | 120 |
| Example 38 | Cu | 1 | 300 | 300 | 0 | DLC | 10 | 0.03 | 120 |
| Example 39 | Cu | 1 | 300 | 300 | 0 | DLC | 220 | 0.73 | 120 |
| Example 40 | Cu | 1 | 300 | 150 | 150 | DLC | 200 | 0.67 | 120 |
| Example 41 | Cu | 1 | 300 | 150 | 150 | DLC | 200 | 0.67 | 120 |
| Example 42 | Cu | 1 | 150 | 150 | 0 | DLC | 30 | 0.2 | None |
| Comparative | Cu | 1 | 300 | 300 | 0 | DLC | 0 | 0.00 | 120 |
| Example 1 | | | | | | | | | |

TABLE 4

| | Evaluation | | | | | |
|---|---|---|---|---|---|---|
| | | Adhesion | Humidity | | | |
| | | strength of | expansion | | Increase in tape | |
| | Young's modulus | vapor-deposited | coefficient | | traveling | SNR |
| | (Gpa) | film | (ppm/% RH) | Cupping | friction | (190kFCI) |
| Example 29 | 10 | ◯ | 2 | ◯ | ◯ | ◯ |
| Example 30 | 11 | ◯ | 1.8 | ◯ | ◯ | ◯ |
| Example 31 | 10.2 | ◯ | 2.8 | ◯ | ◯ | ◯ |
| Example 32 | 10.3 | ◯ | 3.5 | ◯ | ◯ | ◯ |
| Example 33 | 12 | ◯ | 1.3 | ◯ | ◯ | ◯ |
| Example 34 | 7.5 | ◯ | 4.4 | ◯ | ◯ | ◯ |
| Example 35 | 7.5 | ◯ | 4.3 | ◯ | ◯ | ◯ |
| Example 36 | 12 | ◯ | 0.4 | Δ | ◯ | Δ |
| Example 37 | 13 | ◯ | 0.3 | Δ | ◯ | Δ |
| Example 38 | 8.1 | ◯ | 2.2 | Δ | ◯ | Δ |
| Example 39 | 9.2 | ◯ | 2.3 | Δ | ◯ | Δ |
| Example 40 | 9 | ◯ | 2.2 | ◯ | Δ | ◯ |
| Example 41 | 9 | ◯ | 2.1 | ◯ | Δ | ◯ |
| Example 42 | 9 | ◯ | 3.8 | ◯ | ◯ | ◯ |
| Comparative | 6.5 | ◯ | 2.2 | X | ◯ | X |
| Example 1 | | | | | | |

Tables 1 to 4 indicate the following.

By disposing the DLC layer on the metal layer or the metal oxide layer, cupping of the magnetic tape can be suppressed.

By setting the average thickness of the metal layer or the metal oxide layer within a range of 150 nm or more and 500 nm or less, the humidity expansion coefficient can be within a range of 0.5 ppm/% RH or more and 4 ppm/% RH or less. Therefore, dimensional stability of the magnetic tape can be further improved.

By setting the average thickness of the metal layer or the metal oxide layer within a range of 150 nm or more and 500 nm or less and setting a ratio of the average thickness of the DLC layer to the average thickness of the metal layer or the metal oxide layer to 0.05 or more and 0.7 or less, cupping of the magnetic tape can be further suppressed.

Cupping of the magnetic tape can be sufficiently suppressed only by disposing the cupping suppressing layer without performing the step of a heat treatment.

### ii Examples for Electromagnetic Shield

### Example 43

A Cu layer and a DLC layer were laminated on a belt-shaped PEN film (substrate) having a thickness of 6.2 μm in a similar manner to Example 1 except that film forming conditions of the Cu layer and the DLC layer were adjusted such that the average thicknesses of the Cu layer and the DLC layer were the values illustrated in Table 5. As a result, a target electromagnetic shield was obtained.

### Example 44

A CuO layer and a DLC layer were laminated on a belt-shaped PEN film (substrate) having a thickness of 6.2 μm in a similar manner to Example 32 except that film forming conditions of the CuO layer and the DLC layer were adjusted such that the average thicknesses of the CuO layer and the DLC layer were the values illustrated in Table 5. As a result, a target electromagnetic shield was obtained.

[Evaluation]

The magnetic shields in Examples 43 and 44 obtained as described above were evaluated for a Young's modulus, a humidity expansion coefficient, cupping, and an electromagnetic wave transmittance. Note that methods for evaluating a Young's modulus, a humidity expansion coefficient, and cupping were similar to those in Examples 1 to 42 described above.

(Electromagnetic Wave Transmittance)

An electromagnetic wave transmittance of each of the magnetic shields was measured by an ADVANTEST method.

Tables 5 and 6 illustrate the configurations and evaluation results of laminates in Examples 43 and 44.

TABLE 5

| | Reinforcing layer | | | | | | | | |
|---|---|---|---|---|---|---|---|---|---|
| | | | | Average | Average | Cupping suppressing | | | |
| | | | Average | thickness of | thickness of | layer | | Ratio of | Temperature of |
| | | | total | first | second | | Average | average | roll heat |
| | | Layer | thickness | reinforcing | reinforcing | | thickness | thickness | treatment |
| | Material | structure | D1 (nm) | layer (nm) | layer (nm) | Material | D2 (nm) | D2/D1 | (° C.) |
| Example 43 | Cu | 1 | 200 | 200 | 0 | DLC | 30 | 0.15 | 120 |
| Example 44 | CuO | 1 | 200 | 200 | 0 | DLC | 50 | 0.25 | 120 |

TABLE 6

| | Evaluation | | | |
|---|---|---|---|---|
| | | Humidity | | Electromagnetic |
| | Young's | expansion | | wave transmittance |
| | modulus | coefficient | | by ADVANTEST |
| | (Gpa) | (ppm/% RH) | Cupping | method (dB) 500 MHz |
| Example 43 | 9 | 3.8 | ◯ | −40 |
| Example 44 | 11.5 | 2.9 | ◯ | −30 |

Tables 5 and 6 indicate the following.

By disposing the DLC layer on the metal layer or the metal oxide layer, curvature of the electromagnetic shield can be suppressed. As a result, an electromagnetic shield having excellent planarity is obtained.

Hereinabove, the embodiments and Examples of the present technology have been specifically described. However, the present technology is not limited to the above-described embodiments and Examples, and various modifications based on the technical idea of the present technology are possible.

For example, the configurations, the methods, the steps, the shapes, the materials, the numerical values, and the like exemplified in the above-described embodiments and Examples are only examples, and a configuration, a method, a step, a shape, a material, a numerical value, and the like different therefrom may be used, if necessary.

Furthermore, the configurations, the methods, the steps, the shapes, the materials, the numerical values, and the like in the above-described embodiments and Examples can be combined with each other as long as not departing from the gist of the present technology.

Furthermore, the present technology can adopt the following configurations.

(1)

A magnetic recording medium including:

an elongated substrate; and

a reinforcing layer and a cupping suppressing layer disposed on one surface of the substrate.

(2)

The magnetic recording medium according to (1), in which the cupping suppressing layer is a carbon thin film.

(3)

The magnetic recording medium according to (2), in which the carbon thin film contains diamond-like carbon.

(4)

The magnetic recording medium according to any one of (1) to (3), in which the reinforcing layer contains at least one of a metal and a metal compound.

(5)

The magnetic recording medium according to (4), in which the metal compound is a metal oxide.

(6)

The magnetic recording medium according to (4), in which

the metal contains at least one of aluminum and copper, and

the metal compound contains at least one of aluminum oxide, copper oxide, and silicon oxide.

(7)

The magnetic recording medium according to any one of (1) to (6), in which

a tensile stress as an internal stress acts on the reinforcing layer, and

a compressive stress as an internal stress acts on the cupping suppressing layer.

(8)

The magnetic recording medium according to any one of (1) to (7), in which the reinforcing layer has a laminated structure of two or more layers.

(9)

The magnetic recording medium according to any one of (1) to (8), in which the reinforcing layer includes:

a first metal oxide layer;

a second metal oxide layer; and

a metal layer disposed between the first metal oxide layer and the second metal oxide layer.

(10)

The magnetic recording medium according to any one of (1) to (7), in which

the reinforcing layer contains a metal and oxygen, and

an oxygen concentration on a surface on the opposite side to the substrate out of both surfaces of the reinforcing layer is higher than an oxygen concentration inside the reinforcing layer.

(11)

The magnetic recording medium according to (10), in which the oxygen concentrations on both surfaces of the reinforcing layer are higher than the oxygen concentration inside the reinforcing layer.

(12)

The magnetic recording medium according to any one of (1) to (11), in which the cupping suppressing layer has a laminated structure of two or more layers.

(13)

The magnetic recording medium according to any one of (1) to (12), in which

the reinforcing layer is disposed on the substrate, and

the cupping suppressing layer is disposed on the reinforcing layer.

(14)

The magnetic recording medium according to any one of (1) to (13), in which

the reinforcing layer has an average thickness of 150 nm or more and 500 nm or less, and

a ratio of an average thickness of the cupping suppressing layer to an average thickness of the reinforcing layer is 0.05 or more and 0.7 or less.

(15)

The magnetic recording medium according to any one of (1) to (14), having a Young's modulus in a longitudinal direction of 7 GPa or more and 14 GPa or less.

(16)

The magnetic recording medium according to any one of (1) to (15), further including:

a nonmagnetic layer disposed on the other surface of the substrate;

a magnetic layer disposed on the nonmagnetic layer; and

a back layer disposed on the cupping suppressing layer.

(17)

A magnetic recording medium including:

an elongated substrate; and

a reinforcing layer and a carbon thin film disposed on one surface of the substrate.

(18)

A laminate including:

a substrate; and

a reinforcing layer and a cupping suppressing layer disposed on one surface of the substrate.

(19)

The laminate according to (18), in which the substrate has a thickness of 10 μm or less.

(20)

The laminate according to (18) or (19), having surface resistance of 0.4Ω/□ or less on a side on which the cupping suppressing layer is disposed.

(21)

The laminate according to any one of (18) to (20), having a humidity expansion coefficient of 0.5 ppm/% RH or more and 4 ppm/% RH or less.

(22)

A laminate including:

a substrate; and

a reinforcing layer and a carbon thin film disposed on one surface of the substrate.

(23)

A flexible device including the laminate according to any one of (18) to (22).

### REFERENCE SIGNS LIST

10, 111, 121 Laminate
11, 111a Substrate
12 Base layer
13 Recording layer
14, 121b Reinforcing layer
15, 121c Cupping suppressing layer
16 Back layer
110 First conductive element
112, 122 Electrode
120 Second conductive element
130 Microcapsule layer
131 Microcapsule

1. A magnetic recording medium comprising:
an elongated substrate; and
a reinforcing layer and a cupping suppressing layer disposed on one surface of the substrate.

2. The magnetic recording medium according to claim 1, wherein the cupping suppressing layer is a carbon thin film.

3. The magnetic recording medium according to claim 2, wherein the carbon thin film contains diamond-like carbon.

4. The magnetic recording medium according to claim 1, wherein the reinforcing layer contains at least one of a metal and a metal compound.

5. The magnetic recording medium according to claim 4, wherein the metal compound is a metal oxide.

6. The magnetic recording medium according to claim 4, wherein
the metal contains at least one of aluminum and copper, and
the metal compound contains at least one of aluminum oxide, copper oxide, and silicon oxide.

7. The magnetic recording medium according to claim 1, wherein
a tensile stress as an internal stress acts on the reinforcing layer, and
a compressive stress as an internal stress acts on the cupping suppressing layer.

8. The magnetic recording medium according to claim 1, wherein the reinforcing layer has a laminated structure of two or more layers.

9. The magnetic recording medium according to claim 1, wherein the reinforcing layer includes:
a first metal oxide layer;
a second metal oxide layer; and
a metal layer disposed between the first metal oxide layer and the second metal oxide layer.

10. The magnetic recording medium according to claim 1, wherein
the reinforcing layer contains a metal and oxygen, and
an oxygen concentration on a surface on the opposite side to the substrate out of both surfaces of the reinforcing layer is higher than an oxygen concentration inside the reinforcing layer.

11. The magnetic recording medium according to claim 10, wherein oxygen concentrations on both surfaces of the reinforcing layer are higher than the oxygen concentration inside the reinforcing layer.

12. The magnetic recording medium according to claim 1, wherein the cupping suppressing layer has a laminated structure of two or more layers.

13. The magnetic recording medium according to claim 1, wherein
the reinforcing layer is disposed on the substrate, and
the cupping suppressing layer is disposed on the reinforcing layer.

14. The magnetic recording medium according to claim 1, wherein
the reinforcing layer has an average thickness of 150 nm or more and 500 nm or less, and
a ratio of an average thickness of the cupping suppressing layer to an average thickness of the reinforcing layer is 0.05 or more and 0.7 or less.

15. The magnetic recording medium according to claim 1, having a Young's modulus in a longitudinal direction of 7 GPa or more and 14 GPa or less.

16. The magnetic recording medium according to claim 1, further comprising:
a nonmagnetic layer disposed on the other surface of the substrate;
a magnetic layer disposed on the nonmagnetic layer; and
a back layer disposed on the cupping suppressing layer.

17. A magnetic recording medium comprising:
an elongated substrate; and
a reinforcing layer and a carbon thin film disposed on one surface of the substrate.

18. A laminate comprising:
a substrate; and
a reinforcing layer and a cupping suppressing layer disposed on one surface of the substrate.

19. The laminate according to claim 18, wherein the substrate has a thickness of 10 μm or less.

20. The laminate according to claim 18, having surface resistance of 0.4Ω/□ or less on a side on which the cupping suppressing layer is disposed.

21. The laminate according to claim 18, having a humidity expansion coefficient of 0.5 ppm/% RH or more and 4 ppm/% RH or less.

22. A laminate comprising:
a substrate; and
a reinforcing layer and a carbon thin film disposed on one surface of the substrate.

23. A flexible device comprising the laminate according to claim 18.

24. A flexible device comprising the laminate according to claim 22.
